(19) United States
(12) Patent Application Publication
(10) Pub. No.: US 2026/0261453 A1
(43) Pub. Date: Sep. 3, 2026

(54) METHOD AND SYSTEM FOR EXCHANGING DATA IN A MAIN SUBSCRIBER AND SUB-SUBSCRIBER FIELDBUS SYSTEM

(71) Applicant: Beckhoff Automation GmbH, Verl (DE)

(72) Inventors: Holger Büttner, Berlin (DE); Dirk Janssen, Verl (DE); Richard Kümmel, Bielefeld (DE); Erik Vonnahme, Salzkotten (DE); Thorsten Bunte, Gütersloh (DE)

(21) Appl. No.: 19/663,754

(22) Filed: Apr. 30, 2026

Related U.S. Application Data
(63) Continuation of application No. PCT/EP2024/081489, filed on Nov. 7, 2024.

(30) Foreign Application Priority Data
Nov. 7, 2023 (DE) 102023130771.1

(51) Int. Cl. H04L 12/403; H04L 12/40

(52) U.S. Cl. CPC H04L 12/403; H04L 2012/4026

(57) ABSTRACT

In a fieldbus system, sub-subscribers include a functional switch-on unit connected to a sub-switch-on unit. Status information indicating whether the functional switch-on unit is active is recorded in each sub-subscriber. A telegram is output by a main subscriber, including at least one datagram. The status information of the sub-subscriber addressed in the datagram is recorded with the telegram. A counter field is changed by the sub-switch-on unit of sub-user, having processed the user data field in a predefined manner. The datagram is assigned an expected value for the counter field, which results when the user data field has been processed in accordance with the command field. The main subscriber determines the expected value for the counter field on the basis of the status information, and compares it with the value of the counter field processed in order to detect a processing error, in the event of a deviation.

### CROSS-REFERENCE TO RELATED APPLICATIONS

This patent application is a continuation of International Patent Application PCT/EP2024/081489, filed Nov. 7, 2024, entitled “Method for Exchanging Data and Main Subscriber/Sub-Subscriber Fieldbus System,” which claims the priority of German patent application DE 10 2023 130 771.1, filed Nov. 7, 2023, entitled “Verfahren zum Datenaustausch und Main-Teilnehmer/Sub-Teilnehmer-Feldbussystem,” each of which is incorporated by reference herein, in the entirety for all purposes.

### FIELD

The invention relates to a method for exchanging data based on the main subscriber/sub-subscriber principle and a main subscriber/sub-subscriber fieldbus system.

### BACKGROUND

In manufacturing and process automation, fieldbus systems are used in which decentralized devices of a machine periphery, such as input and/or output modules, drives, and operator terminals, are connected to controllers via a fieldbus.

In this context, the exchange of data on the fieldbus is generally based on the main subscriber/sub-subscriber principle. The controllers at the fieldbus are the active bus subscribers, also referred to as main subscribers in the following. The main subscribers have bus access authorization and determine the data transfer on the fieldbus. The passive subscribers, also referred to as sub-subscribers in the following, are usually the machine peripheral devices. The sub-subscribers do not have bus access authorization and can only acknowledge received data or transmit data at the request of a main subscriber.

On the fieldbus, the data between the bus subscribers are preferably transmitted in the form of data packets, also referred to as “telegrams,” in the following. The data from the telegrams are often processed in the sub-subscribers in a continuous process with the aid of sub-switch-on units provided in the sub-subscribers.

When generating telegrams in a main switch-on unit of the main subscriber, the telegrams are preconfigured in such a way that for each sub-subscriber at the fieldbus it is specified with which section in a user data area of the telegram the sub-switch-on unit of the sub-subscriber is to exchange data when passing through or which data transfer process is to be carried out.

The main switch-on unit of the main subscriber also assigns an additional counter field known as a working counter to the user data area in the telegram, which is incremented by the sub-switch-on unit in the sub-subscriber when the sub-switch-on unit in the sub-subscriber exchanges data with the assigned section in the user data area in the telegram as it passes through. The counter field is changed by the sub-switch-on unit in the sub-subscriber in a predefined manner, which is identified for the data transmission process being carried out.

Within the framework of preconfiguring the telegram, the main subscriber determines the value assigned to the telegram for the working counter, which is expected when the user data area in the telegram has been successfully processed by all addressed sub-subscribers in accordance with the specified data transmission processes. After receiving the processed telegram, the main subscriber may then check whether complete telegram processing has taken place by comparing the expected value for the working counter with the actual value of the working counter in the processed telegram.

If the main subscriber detects a processing error by the addressed sub-subscribers during the comparison, the main subscriber discards the telegram to prevent the control task carried out by the main subscriber in the fieldbus system from being falsified due to incorrect telegram processing.

However, if, for example, in a modular control cabinet system, the sub-switch-on unit and a functional switch-on unit, which supplies the sub-switch-on unit with the data to be exchanged with the user data area of the telegram, are implemented in separate units in the sub-subscriber in order to be able to activate or deactivate the functional module containing the functional switch-on unit during operation, the main subscriber also detects a processing error when comparing the counter field values if, in addition to the sub-subscribers in the fieldbus system that have correctly processed data in the user data area of the telegram, one or more sub-subscribers were not involved in the processing due to inactive functional modules.

However, the rejection of the telegram data by the main subscriber in the event of such an actually permissible processing error, which is displayed by the working counter in the telegram, may be critical for the fieldbus system. Discarding the data may lead to communication on a fieldbus being interrupted, and the active functional modules cannot be addressed by the controller. If the functional modules are used in the context of manufacturing and process automation, this may lead to an undesirable loss of production.

### SUMMARY

A method for data transmission based on the main subscriber/sub-subscriber principle and a main subscriber/sub-subscriber fieldbus system are provided in which the main subscriber may recognize which data in the telegram is valid and which data in the telegram is invalid when a telegram is processed by the sub-subscribers.

According to a first aspect, a method for data transmission in a fieldbus system, having a transmission path via which at least one main subscriber and a plurality of sub-subscribers are connected to one another. The sub-subscribers each comprise a sub-switch-on unit and a functional switch-on unit connected to the sub-switch-on unit, wherein status information indicating whether the functional switch-on unit is active or inactive is detected in each sub-subscriber. The main subscriber outputs telegrams on the transmission path, wherein the sub-switch-on units of the sub-subscribers process the telegrams in passage, wherein a telegram output by the main subscriber comprises at least one datagram which includes a control data field, a user data field and a counter field.

The control data field comprises an address field and a command field, the address field designating the sub-subscribers which are to exchange data with the user data field. The command field defines the data transmission operations to be carried out by the sub-subscribers with the user data field. If the command field of the datagram specifies a write operation as the data transmission operation to be carried out by the sub-subscribers, data to be written into the user data field of the datagram is made available to the sub-switch-on unit of the sub-subscriber by the functional switch-on unit when the functional switch-on unit is active. The counter field is changed by the sub-switch-on unit of the sub-subscriber, which has processed the user data field in a predefined manner for the respective data transmission operation being carried out.

The status information of the sub-subscriber addressed in the datagram is recorded with the telegram, wherein the datagram is assigned an expected value for the counter field which results when the user data field has been processed by the addressed sub-subscribers in accordance with the data transmission operations predefined in the command field. The main subscriber determines the expected value for the counter field of the datagram on the basis of the status information recorded with the telegram and compares it with the value of the counter field in the datagram processed by the addressed sub-subscribers in order to determine a processing error in the datagram processed by the addressed sub-subscribers in the event of a deviation.

According to a second aspect, a fieldbus system comprises a transmission path via which at least one main subscriber and a plurality of sub-subscribers are connected to one another. The sub-subscribers each comprise a sub-switch-on unit and a functional switch-on unit connected to the sub-switch-on unit, wherein status information indicating whether the functional switch-on unit is active or inactive is detected in each sub-subscriber. The main subscriber outputs telegrams on the transmission path, wherein the sub-switch-on units of the sub-subscribers process the telegrams in passage, wherein a telegram output by the main subscriber comprises at least one datagram which includes a control data field, a user data field and a counter field.

The control data field comprises an address field and a command field, the address field designating the sub-subscribers which are to exchange data with the user data field. The command field defines the data transmission operations to be carried out by the sub-subscribers with the user data field, wherein. If the command field of the datagram specifies a write operation as the data transmission operation to be carried out by the sub-subscribers, data to be written into the user data field of the datagram is made available to the sub-switch-on unit of the sub-subscriber by the functional switch-on unit when the functional switch-on unit is active. The counter field is changed by the sub-switch-on unit of the sub-subscriber, which has processed the user data field, in a predefined manner for the respective data transmission operation being carried out.

The status information of the sub-subscriber addressed in the datagram is recorded with the telegram, wherein the datagram is assigned an expected value for the counter field, which results when the user data field has been processed by the addressed sub-subscribers in accordance with the data transmission processes predefined in the command field. The main subscriber determines the expected value for the counter field of the datagram on the basis of the status information recorded with the telegram and compares it with the value of the counter field in the datagram processed by the addressed sub-subscribers in order to determine a processing error in the datagram processed by the addressed sub-subscribers in the event of a deviation.

### EXAMPLES

The main subscriber may recognize from the value of the counter field in the datagram of the telegram whether the datagram has been successfully processed by the sub-subscribers. If one or more sub-subscribers have not or only partially processed the datagram, the main subscriber may detect such a processing error by comparing the expected value for the counter field with the actual value of the counter field. To allow for the main subscriber to recognize with as little overhead as possible in the Ethernet telegram which data in the datagram is valid and which data is invalid, status information is recorded in the sub-subscriber to determine whether a functional connection is active in a sub-subscriber. The status information of the sub-subscribers, which indicates whether the functional switch-on unit is active or not active, may be recorded with the aid of the telegram from the main subscriber in order to calculate the expected value for the counter field of the datagram on the basis of the recorded status information.

The telegram output by the main subscriber may comprise a status datagram and a data datagram, wherein the address field of the status datagram and the address field of the data datagram designate the same sub-subscriber. For each addressed sub-subscriber, a data area for status information is provided in the user data field of the status datagram, and a data area for the data to be exchanged is provided in the user data field of the data datagram, with the command field of the status datagram specifying a write operation.

The main subscriber may then determine the expected value for the counter field of the data datagram on the basis of the acquired status information in the status datagram processed by the addressed sub-subscribers and compare it with the value of the counter field in the data datagram processed by the addressed sub-subscribers in order to detect a processing error in the data datagram processed by the addressed sub-subscribers in the event of a deviation. This procedure ensures that the main subscriber receives the status datagram consistently with the data datagram, as both datagrams are in the same telegram. At the same time, however, it is possible to freely select the arrangement of the datagrams in the telegram and also the arrangement of the data areas in the individual datagrams, adapted to the requirements of the fieldbus system.

The main subscriber may also check whether the value in the counter field in the status datagram corresponds to the expected value that results when all addressed sub-subscribers have successfully completed the write process for entering the status information in the user data field of the status datagram. This additional check makes it easier for the main subscriber to find the cause of processing errors in the fieldbus system.

The datagram may be a status/data datagram, alternatively comprising, for each addressed sub-subscriber in the user data field, a section in the data area assigned to the addressed sub-subscriber for the status information that the main subscriber initializes with the status information indicating that the functional connection is not active, wherein the data transmission operations in the command field of the status/data datagram as to be carried out by the sub-subscribers include a write operation.

The main subscriber may determine the expected value for the counter field of the datagram based on the acquired status information in the status/data datagram processed by the addressed sub-subscribers and compare it with the value of the counter field in the status/data datagram processed by the addressed sub-subscribers to determine a processing error in the status/data datagram processed by the addressed sub-subscribers if there is a discrepancy. With the aid of this procedure, the status information may be recorded without necessitating a change of the telegram structure.

The status information that indicates whether a functional activation is active or not may be a 1-bit date, which keeps the additional data volume to a minimum.

The telegrams may be in the form of Ethernet telegrams, wherein the EtherCAT protocol is used as the Ethernet protocol type for interpreting the datagrams.

In the fieldbus system, the sub-switch-on unit and the functional connection may be realized in units that may be separated from one another in the sub-subscriber. The fieldbus system may be embodied with a base module and a functional module, wherein the base module comprises the sub-switch-on unit, which is connected to a base connection element, wherein the functional module comprises the functional connection, which is connected to a module connection element, and wherein the base connection element and the module connection element form a plug connection.

The fieldbus system may be embodied to be modular so that the sub-switch-on unit and a functional switch-on unit, which supplies the sub-switch-on unit with the data to be exchanged with the user data area of the telegram, are implemented in separate units in the sub-subscriber. The status information in the status datagram, on the basis of which the expected value for the counter field of the data datagram is calculated, prevents the main subscriber from detecting a processing error when comparing the counter field values even if, in addition to the sub-subscribers in the fieldbus system that have correctly processed data in the user data area of the telegram, one or more sub-subscribers were not involved in the processing due to inactive functional modules.

The base module may have a plurality of sub-switch-on units, which are connected to one another and to a fieldbus connection via a serial data bus, each sub-switch-on unit being connected to a base connection element into which the module connection element of a functional module may be plugged.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 schematically shows the structure of a fieldbus system.

FIG. 2 schematically shows the structure of an Ethernet telegram.

FIG. 3 schematically shows the structure of a datagram in the Ethernet telegram.

FIG. 4 schematically shows a modular control cabinet system having a base module and functional modules.

FIG. 5 shows the base module from FIG. 4.

FIG. 6 shows the functional module from FIG. 4.

FIG. 7 shows a schematic cross-section of the base module in FIG. 4.

FIGS. 8A and 8B schematically show the structure of a status datagram and a status datagram in the Ethernet telegram.

FIG. 9 shows the structure of a status/data datagram in the Ethernet telegram.

### DETAILED DESCRIPTION

In industrial automation, communication networks are used in the form of serial bus systems in which decentralized devices of a machine periphery communicate with controllers. The bus subscribers are networked with one another via a fieldbus. The data exchange between the bus subscribers is packet-oriented in the form of telegrams based on the main subscriber/sub-subscriber principle, wherein the main subscribers determine the data transfer on the fieldbus.

Fieldbus systems with main subscriber/sub-subscriber architecture may be operated by different transmission protocols, wherein protocols based on Ethernet technology are preferred for telegram transmission.

The Ethernet telegram is 1518 bytes long by default, with 18 bytes reserved for a header section and an end section. The header section of the Ethernet telegram contains a data field that specifies the Ethernet protocol type with the aid of which the user data in the Ethernet telegram is to be interpreted.

In industrial automation, protocol types that guarantee real-time capability are also preferred. One such real-time standard for Ethernet technology is the EtherCAT protocol, in which the user data in the Ethernet telegram is processed by the sub-subscribers in passage.

In the EtherCAT protocol, the user data block in the Ethernet telegram is divided up into a header, also referred to as the EtherCAT header, and one or more datagrams. The EtherCAT header contains characteristic data fields that define the length of the datagrams, among other things.

The datagrams in turn comprise a header section, an end section, and a user data section between. An address field and a command field are provided in the header section of the datagram, also known as the datagram header. The address field designates the sub-subscribers that are to exchange data with the user data section in the datagram when the datagram passes through. The command field then specifies the data transfer operations to be carried out with the aid of the addressed sub-subscribers, wherein the data transfer operation may be a read operation, a write operation or a combined read/write operation.

The invention is described below using the example of an Ethernet-based fieldbus system in which the EtherCAT protocol is used for data transmission. However, the invention is neither limited to the Ethernet-based fieldbus system nor to the EtherCAT protocol. In principle, the invention may be used with all fieldbus systems in which the sub-subscribers are to process telegram data in a continuous process. For example, the Ethernet-based Sercos 3 protocol may be used as an alternative.

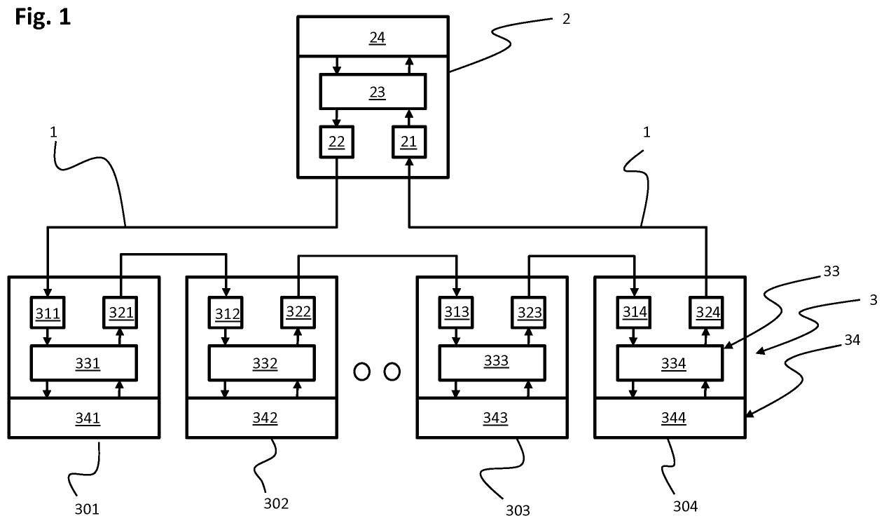

FIG. 1 schematically shows a possible layout of a fieldbus system. The fieldbus system comprises a transmission path 1, for example, an electrical line or an optical fiber. The bus subscribers are connected to the transmission path 1. FIG. 1 shows an embodiment having a main subscriber 2 and four sub-subscribers 3, a first sub-subscriber 301, a second sub-subscriber 302, a third sub-subscriber 303 and a fourth sub-subscriber 304.

In EtherCAT technology, it is possible to network a main subscriber with up to 65534 sub-subscribers. A plurality of main subscribers may also be connected to the transmission path at the same time. The main subscribers and the sub-subscribers may be integrated directly into the transmission path or connected to the transmission path via a separate switch-on unit module. Circles are shown as placeholders between the second sub-subscriber 302 and the third sub-subscriber 303 to illustrate the expansion possibilities of the fieldbus system shown in FIG. 1.

The execution of the data transmission on the transmission path 1 is determined by the communication protocol, in this example, by the EtherCAT protocol. The EtherCAT protocol is implemented in the main subscriber 2 in a main switch-on unit 23. The communication protocol parts required for the sub-subscriber 3 are stored in a sub-switch-on unit 33.

The EtherCAT network logically represents an open ring bus in which the main subscriber 2 outputs Ethernet telegrams to transmission path 1 at one end and receives them back processed by the sub-subscribers 3 at the other end.

As FIG. 1 shows, telegram transmission takes place in such a way that the main switch-on unit 23 of main subscriber 2 outputs the Ethernet telegram via a main transmitter 22 to the first sub-subscriber 301 on transmission path 1 as seen by main transmitter 22 in main subscriber 2.

The first sub-subscriber 301 receives the Ethernet telegram via a first sub-receiver 311, processes the Ethernet telegram on the fly with the aid of a first sub-switch-on unit 331 and forwards the processed Ethernet telegram, delayed by a few bits, via a first sub-transmitter 321 to the second sub-subscriber 302 on transmission path 1.

The second sub-subscriber 302 receives the Ethernet telegram via a second sub-receiver 312, processes the Ethernet telegram on the fly with the aid of a second sub-switch-on unit 332 and forwards the processed Ethernet telegram, delayed by a few bits, via a second sub-transmitter 322 to the third sub-subscriber 303 on transmission path 1.

The third sub-subscriber 303 receives the Ethernet telegram via a third sub-receiver 313, processes the Ethernet telegram on the fly with the aid of a third sub-switch-on unit 333 and forwards the processed Ethernet telegram, delayed by a few bits, via a third sub-transmitter 323 to the fourth sub-subscriber 304 on transmission path 1.

The fourth sub-subscriber 304 receives the Ethernet telegram via a fourth sub-receiver 314, processes the Ethernet telegram on the fly with the aid of a fourth sub-switch-on unit 334 and forwards the processed Ethernet telegram, delayed by a few bits, back to a main receiver 21 of the main subscriber 2 via a fourth sub-transmitter 324.

In a network operated with the EtherCAT protocol, the transmission path may also be embodied in a directional manner, unlike shown in FIG. 1, wherein the transmission path forms a physical line as seen from the main subscriber, and the Ethernet telegrams are passed through twice by all sub-subscribers, namely on the outward path and on the return path. The telegram processing by the sub-switch-on units in the sub-subscribers preferably takes place on the outward path. The return path is used for signal amplification and for localizing and closing interruptions on the transmission path. The line structure may also be expanded into a flexible tree structure by branching off at any sub-subscribers.

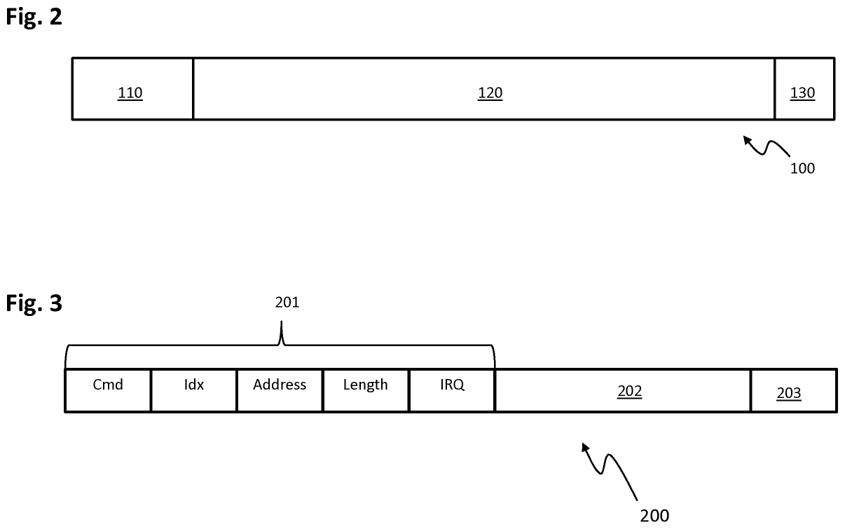

The telegram is generated in the main switch-on unit 23 of the main subscriber 2. With the EtherCAT protocol, the main switch-on unit 23 in the main subscriber 2 generates an Ethernet telegram 100, as shown in FIG. 2. The Ethernet telegram is made up of a header data field 110, also referred to below as the Ethernet header, a user data field 120 and a check character field 130 at the end.

The destination and source addresses are defined in the Ethernet header 110. The Ethernet header 110 also specifies which protocol is to be used to interpret the data in the user data field 120. In the embodiment example shown, the EtherCAT protocol is displayed in the Ethernet header 110. The check character field 130 at the end of the Ethernet telegram indicates a so-called FCS (Frame Check Sequence) in order to be able to detect errors during data transmission.

The user data field 120 in the Ethernet telegram 100 then contains the actual EtherCAT data packet, which may have a length of up to 1500 bytes in the standard Ethernet telegram frame. The EtherCAT data packet in turn consists of a header, also known as the EtherCAT header, and one or more datagrams. If the entire Ethernet telegram is smaller than 64 bytes, so-called padding bytes are inserted after the datagrams at the end of the EtherCAT data packet. The EtherCAT header contains a length specification, a reserved bit and a specification of the protocol type.

FIG. 3 shows an example of the datagram structure. The datagram 200 consists of a control data field 201, a user data field 202 and an end field 203. The control data field 201 comprises a command field Cmd, an identification field Idx, an address field Address, a length field Length and an interrupt field IRQ.

The Cmd command field specifies, among other things, how the datagram is to be processed by the sub-subscribers. The Cmd command field may use a first value to identify the datagram as a read datagram in which the sub-subscribers are to read the user data field 202 in the datagram. With a second value, the Cmd command field may alternatively identify the datagram as a write datagram into the user data field 202, into which the sub-subscribers are then to write data. A third value in the Cmd command field may identify the datagram as a read/write datagram in which data is to be read from the user data field 202 and data is to be written to the user data field 202 the sub-subscribers. With a fourth value, the Cmd command field may identify the datagram as an empty datagram in which the sub-subscribers should leave the user data field unchanged.

The main subscriber uses the identification field Idx to identify datagram 200 so that it may be assigned again after receipt.

The Address field specifies which sub-subscriber or sub-subscribers are selected to carry out the data exchange process specified in the Cmd command field. Addressing may be carried out in various ways, depending on the network requirements.

It is possible to physically address a single sub-subscriber, a number of sub-subscribers or all sub-subscribers as part of broadcast telegrams. Alternatively, however, logical addressing may also be used. With logical addressing, the physical addresses of the sub-subscribers are assigned to logical addresses in advance, wherein the assignment is pre-stored in FMMU units (Fieldbus Memory Management Unit), which are part of the sub-subscribers' sub-switch-on units.

When a datagram with logical addressing is received, the sub-switch-on unit in the sub-subscriber checks whether an address match with the stored logical addresses is provided and then determines the corresponding assigned physical address in the sub-subscriber. With logical addressing, it is possible to map any memory areas in the sub-subscriber, even bit by bit, to any logical addresses and thus address a large number of sub-subscribers simultaneously, for example, with the aid of a datagram. Logical addressing is particularly suitable for transferring process data between the main subscriber and the sub-subscribers. Physical addressing is preferably used to transmit parameter data.

The length field Length in the control data field 201 of the datagram 200 indicates the length of the user data field 202.

The interrupt field IRQ defines an interrupt to be displayed by the sub-subscriber to the main subscriber.

The user data field 202 of datagram 200 contains the data to be exchanged between the main subscriber and the sub-subscribers.

The end field 203 is a counter field, also referred to below as a working counter, for example, with a size of 16 bits. Each sub-subscriber that is addressed and has processed the datagram 200 according to the specification in the Cmd command field increments the value in the working counter 203. The working counter 203 is set to a predefined value, usually 0, by the main switch-on unit 23 of main subscriber 2 during telegram generation. The value in the working counter 203 is then changed by the addressed sub-subscriber in a predefined manner if the addressed sub-subscriber has successfully carried out a read operation, a write operation, or a read/write operation. Table 1 below shows a possible procedure for the sub-subscriber when incrementing the counter field 203:

TABLE 1
Procedure

| Command | Execution | Working Counter |
|---|---|---|
| Read | No success | No change |
| operation | Successful reading | +1 |
| Write | No success | No change |
| operation | Successful writing | +1 |
| Read/write | No success | No change |
| operation | Successful reading | +1 |
| | Successful writing | +2 |
| | Successful reading and writing | +3 |

Each datagram may thus be assigned a value for the working counter, which is expected after the telegram has passed through all sub-subscribers. The main subscriber may then check whether a datagram has been processed successfully by comparing the expected value for the working counter with the actual value of the working counter that arrives after passing through all sub-subscribers.

As further shown in FIG. 1, the main switch-on unit 23 in the main subscriber 2 is connected to a processor 24 in the main subscriber 2. The processor 24 of the main subscriber 2 carries out the control tasks, wherein the processor 24 uses input process images for individual control tasks in order to determine output process images from them. The input or output process image of the individual control task is generally assigned at least one datagram in the Ethernet telegram.

As described in FIG. 1, the datagram 200 is processed in the sub-subscribers 3 as it passes through the respective sub-switch-on unit 33. The Ethernet telegram 100 is transmitted from one sub-subscriber 3 to the next sub-subscriber 3 with a delay of a few bits. The sub-switch-on unit in sub-subscriber 3 evaluates the control data field 201 of datagram 200 in order to determine which data transmission process is to be carried out with the user data field 202 of datagram 200 using the command field Cmd. Using the address field Address, the sub-switch-on unit 33 in the sub-subscriber 3 then determines whether a data area is addressed in the sub-subscriber 3 with which the sub-subscriber 3 is to exchange data when passing through the user data field 202.

The sub-switch-on unit 33 of the sub-subscriber 3 is further connected to a functional switch-on unit 34 in order to process the user data intended for the sub-subscriber 3. In the embodiment shown in FIG. 1, the first sub-subscriber 301 comprises a first functional switch-on unit 341, the second sub-subscriber 302 comprises a second functional switch-on unit 342, the third sub-subscriber 303 comprises a third functional switch-on unit 343 and the fourth sub-subscriber 304 comprises a fourth functional switch-on unit 344.

During a read operation, the sub-switch-on unit 33 of sub-subscriber 3 reads the user data assigned to sub-subscriber 3 from the user data field 202 in datagram 200 of Ethernet telegram 100 and forwards the user data to the assigned functional switch-on unit 34, which then stores the user data in the addressed memory area in sub-subscriber 3.

During a write operation, the functional switch-on unit 34 in the sub-subscriber 3 makes the user data from the addressed memory area available to the sub-switch-on unit 33 in the sub-subscriber 3 so that the sub-switch-on unit 33 may then write the user data into the assigned area in the user data field 202 of the datagram 200.

When fieldbus systems are used in industrial automation, the sub-switch-on unit and the functional connection are often implemented in separate units in the sub-subscribers. One possible example is a modular control cabinet system having a base module containing basic sub-switch-on units and plug-in functional modules containing the functional connection.

In principle, the functional modules may provide any functionality. The functional modules in a control cabinet system may, for example, be input modules, output modules, control modules, main filter modules, contactor modules, frequency converter modules, power supply modules, etc., or any combination of the mentioned modules.

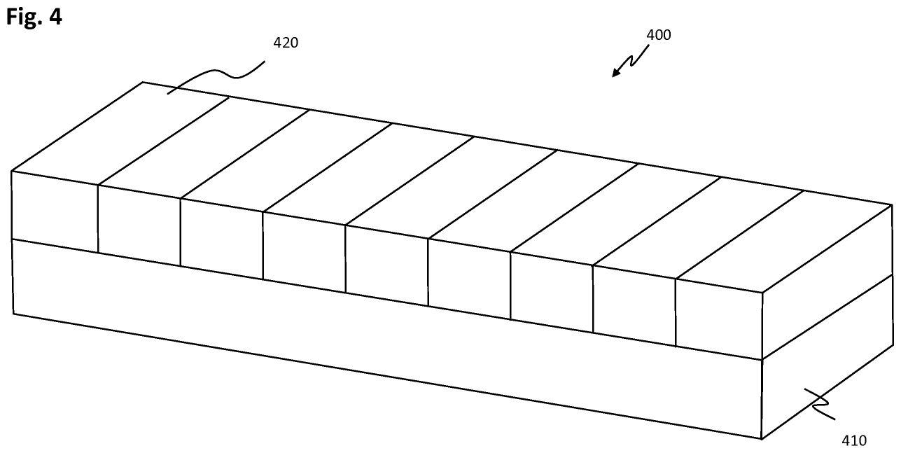

FIG. 4 schematically shows a possible structure of a modular control cabinet system 400 in a perspective view having a base module 410 and a plurality of functional modules 420, in this context eight functional modules.

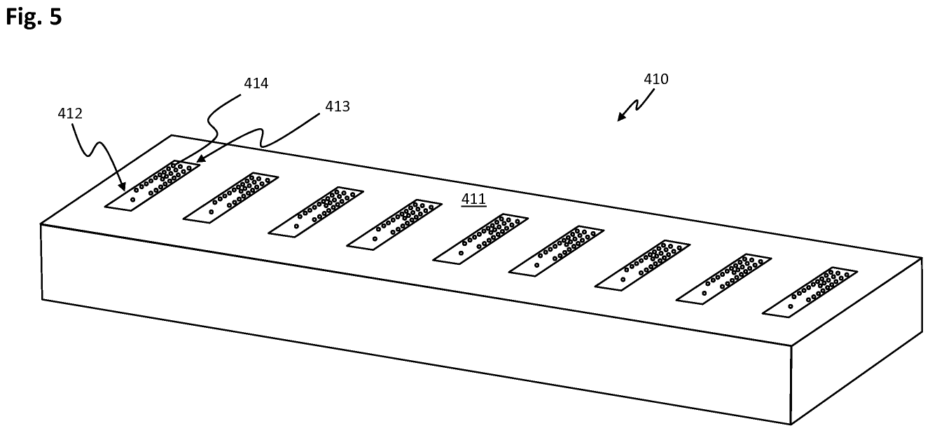

The base module 410 is shown in more detail in FIG. 5. In a rectangular housing 411, eight openings, one opening for each functional module, are embedded in an upper side. A base connection element 413 with contacts 414 is arranged in the area of each opening 412. The contacts 414 may be embodied as contact pins or as contact openings in order to serve either as plugs or as sockets.

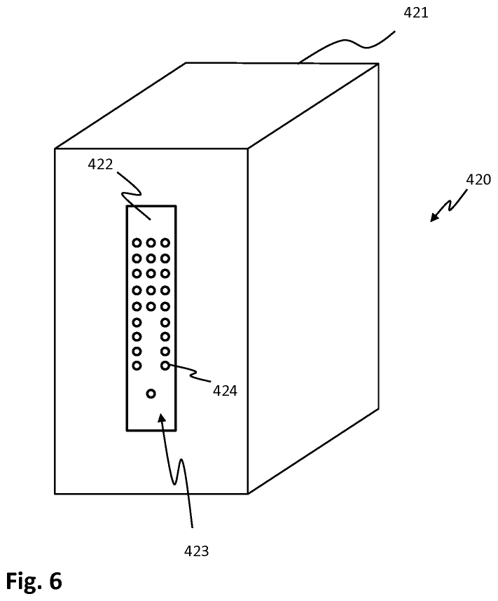

FIG. 6 schematically shows a functional module 420 in a perspective view. The functional module 420 comprises a module housing 421 having an opening 422 in an underside. A module connection element 423 with contacts 424 is arranged in the area of the opening 422 of the functional module 420. The contacts 424 of the module connection element 423 may in turn be embodied either as contact pins or as contact openings in order to engage in the corresponding contacts of a base connection element in the base module n.

The basic connection elements and the module connection elements generally comprise data connections, extra-low voltage connections, and low voltage connections. Instead of one row of openings with basic connection elements, the base module may also have a plurality of adjacent rows of openings with basic connection elements. Instead of one opening having one module connection element, the functional modules may also comprise a plurality of openings having module connection elements. Furthermore, the functional modules may then cover a plurality of openings in the base module with base connection elements.

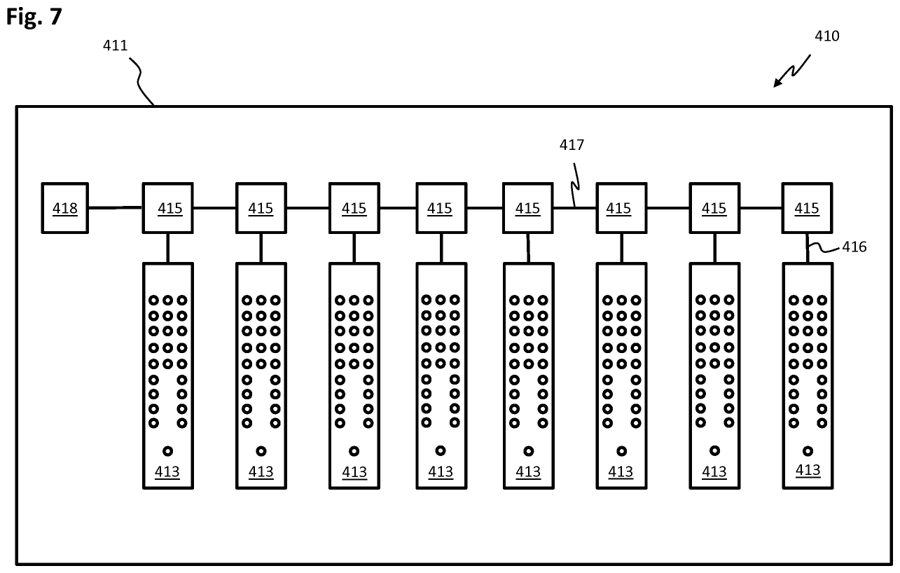

As the schematic cross-section through the base module 410 in FIG. 7 shows, each base connection element 413 is assigned a base sub-switch-on unit 415, the base sub-switch-on unit 415 being connected to one of the base connection elements 413 via a data line 416 in order to exchange data with the functional module 420 plugged into the corresponding base connection element 413.

The basic sub-switch-on units 415 are connected to one another via a serial data bus 417 and also to a fieldbus connection 418. Telegrams may be fed into the data bus 417 via the fieldbus connection 418.

The fieldbus connection may also be formed by a basic connection element. If the fieldbus connection is embodied as a basic connection element, an assigned basic sub-switch-on unit may be omitted, as no processing of the fed-in data is required.

Furthermore, a further fieldbus connection may be provided in the base module 410 in order to transmit the telegrams, which are fed into the base module 410 via the one fieldbus connection 418, to a downstream further base module via the further fieldbus connection.

The additional fieldbus connection may again be embodied as a basic connection element, in which case there is no need for an associated basic sub-switch-on unit, as the data fed in does not have to be processed. The additional fieldbus connection may also share a basic connection element with the fieldbus connection 418.

The modular control cabinet system 400 offers the advantage that in the event of a defect or replacement of a functional module, the other functional modules plugged onto the base module may be addressed. When using the control cabinet system 400 in a production system, for example, production downtime may be prevented if a functional module is replaced.

As described, the main subscriber may recognize from the value of the working counter in the datagram of the Ethernet telegram that has passed through the sub-subscribers on the fieldbus system whether the datagram has been successfully processed by the sub-subscribers. If one or more sub-subscribers have not processed the datagram or only partially processed the datagram, the main subscriber may detect such a processing error by comparing the expected value for the working counter with the actual value of the processed working counter.

If the main subscriber detects a processing error in this way, the main subscriber may discard the data in the datagram. This is necessary if, for example, an error occurs in a sub-subscriber of the fieldbus system, which then leads to input or output process images for the control task to be carried out by the main subscriber being corrupted.

However, if the sub-switch-on unit and the functional connection are realized in separate units in the sub-subscriber, as in the control cabinet system, in order to be able to insert or remove the functional module containing the functional connection in the fieldbus system during operation in the form of a pull-and-plug unit, the main subscriber also detects a processing error if the sub-subscribers in the fieldbus system have actually processed the data in the datagram correctly, but one or more sub-subscribers were not involved in processing the datagram due to inactive or unplugged functional modules.

In fieldbus systems such as the control cabinet system, the control tasks carried out by the main subscriber do not depend on all sub-subscribers on the fieldbus system being active and processing data. In such fieldbus systems, it is possible to activate or deactivate functional modules during operation, for example, by plugging the functional module into the base module or removing the functional module from the base module in the control cabinet system shown in FIG. 4.

During Ethernet telegram generation in the main switch-on unit of the main subscriber, the datagrams in the EtherCAT data packet are preconfigured in such a way that they are defined for each sub-subscriber on the fieldbus system with the aid of which data area of the user data field in the datagram of the sub-subscriber data are to be exchanged when passing through or which data transfer process is to be carried out.

As part of this pre-configuration, the main subscriber also determines the value assigned to each datagram for the working counter, which is expected when the datagram has been successfully processed by all addressed sub-subscribers. However, the pre-configuration by the main subscriber does not take into account whether the functional module of the sub-subscriber is active or not, i.e., whether the functional module of the corresponding sub-subscriber is plugged into the base module or not in the control cabinet system shown in FIG. 4.

If the addressed sub-subscriber does not process the datagram with the aid of its sub-subscriber when the Ethernet telegram passes through due to the inactive functional switch-on unit, which does not supply any data, the sub-subscriber will not increment the working counter in the datagram. When comparing the expected value for the working counter with the actual value of the working counter that arrives after passing through all sub-subscribers, the main subscriber therefore detects a deviation and would normally discard the datagram data.

Discarding the datagram data during operation by the main subscriber in the event of such a permissible processing error may, however, be critical for the fieldbus system with a basically error-free sub-subscriber. Discarding the datagram data leads to communication on a fieldbus being interrupted so that the active functional modules cannot be addressed by the controller. If the functional modules are used in a production system, for example, this could result in an undesirable production downtime.

If the fieldbus system is used as a modular control cabinet system, as shown in FIG. 4, discarding the datagram data would also mean that functional modules cannot be replaced during operation. In the worst-case scenario, the production system operated with the modular control cabinet system would have to be shut down in order to be able to restart communication on the fieldbus after a functional module has been replaced.

In order for the main subscriber to be able to recognize with as little overhead as possible in the Ethernet telegram which data in the datagram is valid and which data is invalid, it is intended that status information be recorded in the sub-subscriber to determine whether a functional switch-on unit is active in a sub-subscriber, i.e., whether, for example, the functional module for a sub-switch-on unit is plugged into the base module in the control cabinet system shown in FIG. 4.

The status information of the sub-subscribers, which indicates whether the respective functional switch-on unit is active or not active, may be recorded by the main subscriber with the aid of the Ethernet telegram. Based on the recorded status information, the main subscriber may then recalculate the expected value for the working counter of the datagram in the Ethernet telegram.

The status information, which indicates whether a functional switch-on unit is active or inactive, may be a 1-bit datum. To record the status information, a functional switch-on unit query unit may be provided in the sub-switch-on unit, which checks the operating status of the functional switch-on unit. This may be carried out, for example, in the modular control cabinet system 400 shown in FIG. 4, in that the functional switch-on unit interrogation unit in the basic sub-switch-on unit 415 checks via the data line 416 whether data exchange is possible with a functional module 420 plugged into the associated basic connection element 413. Instead of an active check by the sub-switch-on unit, the functional switch-on unit in the functional module 420 may also be embodied to output corresponding status information to the sub-switch-on unit in the active state. The status information is then entered in a corresponding status register in the sub-switch-on unit.

The status information may be recorded using an additional datagram in the telegram output by the main subscriber. The telegram then comprises a status datagram and a data datagram.

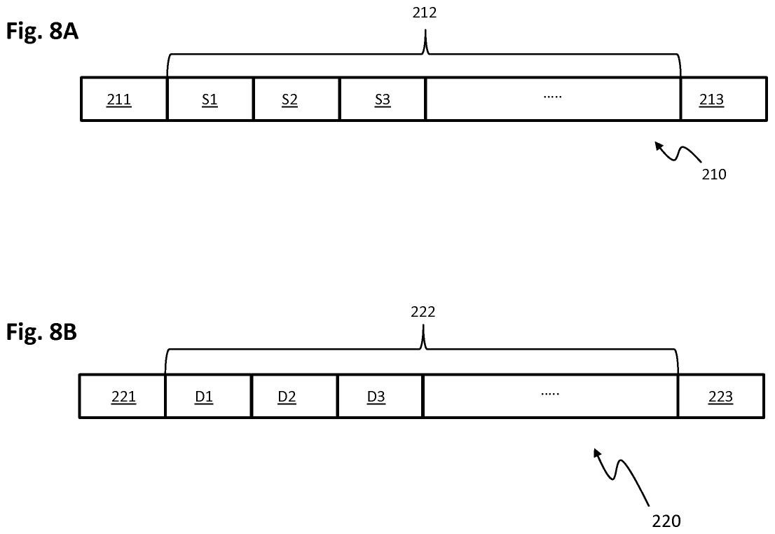

FIGS. 8A and 8B show examples of the structure of the status datagram 210 for reading status information (FIG. 8A) and the structure of the data datagram 220 for transmitting data (FIG. 8B). The structure of the status datagram 210 and the data datagram 220 corresponds to the datagram structure shown in FIG. 3 with a control data field, a user data field and an end field.

The control data field 211 of the status datagram 210 and the control data field 221 of the data datagram 220 each comprise the command field Cmd, the identification field Idx, the address field Address, the length field Length and the interrupt field IRQ. The main switch-on unit of the main subscriber configures the control data field 211 of the status datagram 210 and the control data field 221 of the data datagram 220 so that the same sub-subscribers are addressed in the address field Address. The command field Cmd of the control data field 211 of the status datagram 210 is set to a write operation by the main circuit of the main subscriber, whereas the command field Cmd of the control data field 221 of the data datagram 220 may be any data transfer operation, i.e., a read operation, a write operation, or a read/write operation.

For each sub-subscriber, a data area is then provided for a status bit in the user data field 212 of the status datagram 210, which is indicated in FIG. 8 by S1, S2, S3, etc., and a data area for the data to be exchanged in the user data field 222 of the data datagram 220, which is indicated in FIG. 8 by D1, D2, D3, etc. The order of the data areas assigned to the individual sub-subscribers in the user data field of the status datagram may differ from the order of the data areas assigned to the individual sub-subscribers in the user data field of the data datagram. The end field 213 in the status datagram 210 and the end field 223 in the data datagram 220 are each a working counter that is incremented by each sub-subscriber that has processed the assigned data area in the user data field 212 of the status datagram 210 or in the user data field 222 of the data datagram 220.

In the status datagram 210, each addressed sub-subscriber carries out a write operation with the sub-switch-on unit in accordance with the data exchange operation specified in the Cmd command field of the control data field 211 of the status datagram 210, so that the counter value in the working counter 213 of the status datagram 210 is incremented by the value 1 in accordance with Table 1 if the status bit has been successfully entered by the sub-switch-on unit in the assigned data area in the user data field 212 of the status datagram 210.

In the data datagram 220, each addressed sub-subscriber with the sub-switch-on unit increments the working counter 223 of the data datagram 220 with the value in the user data field 222 of the data datagram 220 when a data exchange operation is successfully executed. When a read operation or a write operation is successfully executed, the sub-switch-on unit of the sub-subscriber according to Table 1 increments the working counter 223 by the value 1 in each case. In the case of a read/write operation, the sub-switch-on unit of the sub-subscriber according to Table 1 increases the working counter 223 by the value 1 for the successful read operation and by the value 2 for the successful write operation, so that the working counter 223 is increased by the value 3 for the fully executed read/write operation.

The status datagram 210 and the data datagram 220 may be arranged anywhere in the EtherCAT data packet. Further datagrams may also be inserted into the EtherCAT data packet.

After passing through the sub-subscribers, the main subscriber receives the status datagram 210 consistently with the data datagram, as both datagrams are in the same Ethernet frame.

The main subscriber may then first check whether the value in the working counter 213 in the status datagram 210 corresponds to the expected value. The expected value of the working counter 213 in the status datagram 210 is the value that results when all addressed sub-subscribers have successfully carried out the write operation to enter the status bit in the user data field 212 of the status datagram 210. With the aid of this check, the main subscriber may determine whether the sub-switch-on units of the sub-subscribers are working correctly. If an error is detected, the main subscriber may react to such anomalous behavior in the fieldbus system in accordance with a specification. For example, a diagnostic process may be triggered for precise error detection in the sub-switch-on unit of the sub-subscriber.

The main subscriber may also evaluate the status bits in the user data field 212 of the status datagram 210 in order to calculate the expected value for the working counter 223 of the data datagram 220. The main subscriber carries out this evaluation in such a way that the number of addressed sub-subscribers is reduced by the sub-subscribers, the status bit of which indicates that the functional connection is not active. On the basis of the corrected number of sub-subscribers, the main subscriber then calculates the expected value for the data datagram 220 using the data transmission process provided in the Cmd command field of the data datagram 220.

The main subscriber then further compares the actual value in the working counter 223 of the data datagram 220 with this expected value in order to determine whether the user data field 222 of the data datagram 220 has been successfully processed. If a processing error is detected, the main subscriber may then discard the data in the data datagram 220. In turn, the main subscriber may also carry out a more detailed error diagnosis.

In the modular control cabinet system 400 shown in FIGS. 3 to 6, the eight basic sub-switch-on units 415 shown may each be addressed in the control data field 211 of the status datagram 210 and in the control data field 221 of the data datagram 220. The user data field 212 of the status datagram 210 would then have eight data areas for status bits and the user data field 222 of the data datagram 220 would have eight data areas for data to be exchanged. If the data datagram 220 is identified as a read/write datagram in the command field Cmd of the control data field 221, the expected value according to Table 1 for the modular control cabinet system 400 would be 24.

Assuming that a functional module in the modular control cabinet system 400 is not plugged in, the status bit of the assigned basic sub-switch-on unit 415 would then have the value 0 instead of the value 1, as in the case of plugged-in functional modules. On the basis of a successfully processed status datagram 210, the status information would then indicate that the expected value for the data datagram 220 is not 24 but 21. The main switch-on unit would then check the actual value in the working counter 223 of the processed data datagram 220 on the basis of this corrected expected value in order to detect a processing error.

Instead of using an additional status datagram in the telegram output by the main subscriber, the status information may also be recorded using a single datagram that is also used to transmit data. The datagram referred to below as status/data datagram then also contains a section in the data area assigned to the addressed sub-subscriber for the status information for each addressed sub-subscriber in the user data field.

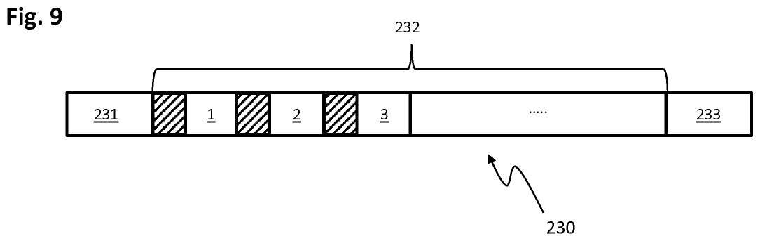

FIG. 9 shows an example of the structure of the status/data datagram 230 for reading status information and transmitting data. The structure of the status/data datagram 230 corresponds to the datagram structure shown in FIG. 3 having a control data field, a user data field, and an end field.

The control data field 231 of the status/data datagram 230 comprises the command field Cmd, the identification field Idx, the address field Address, the length field Length and the interrupt field IRQ. In the Cmd command field, a write operation or a read/write operation is specified by the main switch-on unit of the main subscriber as a data transfer operation.

For each sub-subscriber addressed in the address field Address of the control data field 231, a section is then provided in the data area assigned to the addressed sub-subscriber for a status bit in the user data field 232 of the status/data datagram 230. The section for the status bit may be located anywhere in the data area and is shown in a hatched manner in FIG. 9. The main subscriber initializes the section for the status bit in the data area assigned to the addressed sub-subscriber in such a way that it is indicated that the functional switch is not active.

The end field 233 in the status/data datagram 230 comprises the working counter, which is incremented by each sub-subscriber that has processed the assigned data area in the user data field 232.

When the telegram passes through, the sub-switch-on unit in the addressed sub-subscriber carries out at least one write operation in accordance with the data exchange operation specified in the Cmd command field of the control data field 232 of the status/data datagram 230 if the functional switch-on unit is active. The sub-switch-on unit in the addressed sub-subscriber then overwrites the section for the status bit in the data area assigned to the addressed sub-subscriber with the status bit indicating that the functional connection is active. Furthermore, the sub-switch-on unit in the addressed sub-subscriber increments the working counter 233 of the status/data datagram 230 when the data exchange process is successfully carried out with the assigned data area in the user data field 232 in accordance with Table 1.

After receiving the processed status/data datagram 230, the main subscriber may then evaluate the status bits in the user data field 232 of the status/data datagram 230 in order to calculate the expected value for the working counter 233 of the status/data datagram 230. The main subscriber carries out this evaluation in such a way that the number of addressed sub-subscribers is reduced by the sub-subscribers, the status bit of which indicates that the functional connection is not active, i.e., for which the overwriting of the section for the status bit has not taken place and, according to the initialization by the main subscriber, the section for the status bit continues to indicate that the functional connection is not active. On the basis of the corrected number of sub-subscribers, the main subscriber then calculates the expected value for the status/data datagram 230 on the basis of the data transmission process provided for in the Cmd command field of the status/data datagram 230.

The main subscriber further compares the actual value in the working counter 233 of the status/data datagram 230 with this expected value in order to determine whether the user data field 232 of the status/data datagram 230 has been successfully processed. Upon detecting a processing error, the main subscriber may then discard the data in the status/data datagram 230. In addition, the main subscriber may carry out an error diagnosis.

If, in the modular control cabinet system 400 shown in FIGS. 3 to 6, the eight basic sub-switch-on units 415 shown are addressed, the status bit indicating that the functional connection is not active, for example, the value 0, is then entered in the status bit section of the eight data areas in the user data field 232 of the status/data datagram 230.

Assuming that a functional module in the modular control cabinet system 400 is not plugged in, the assigned basic sub-switch-on unit, unlike the other basic sub-switch-on units, would then not overwrite the section for the status bit with the status bit indicating that the functional switch-on unit is active, i.e., with the value 1. The status information in the processed status/data datagram 230 would then indicate that the expected value for the status/data datagram 230 is 21, based on table 1 for the working counter change. The main switch-on unit would then check the actual value in the working counter 233 of the processed status/data datagram 230 on the basis of this corrected expected value in order to detect a processing error.

Although the invention has been further illustrated and described in detail by embodiments, the invention is not limited by the disclosed examples and other variations may be derived therefrom by those skilled in the art without departing from the scope of protection of the invention.

TABLE 2
List of reference numerals

1 Transmission path
2 Main subscriber
3 Sub-subscriber
21 Main receiver
22 Main transmitter
23 Main switch-on unit
24 Processor
33 Sub-switch-on unit
34 Functional switch-on unit
100 Telegram/Ethernet telegram
110 Ethernet header/header data field
120 User data field
130 Check sum field
200 Datagrams
201 Control data field
202 User data field
203 End field/Counter field/Working counter
210 Status datagram
211 Control data field
212 User data field
213 Working counter
220 Data datagram
221 Control data field
222 User data field
223 Working counter
301 First sub-subscriber
302 Second sub-subscriber
303 Third sub-subscriber
304 Fourth sub-subscriber
311 First sub-receiver
312 Second sub-receiver
313 Third sub-receiver
314 Fourth sub-receiver
321 First sub-transmitter
322 Second sub-transmitter
323 Third sub-transmitter
324 Fourth sub-transmitter
331 First sub-switch-on unit
332 Second sub-switch-on unit
333 Third sub-switch-on unit
334 Fourth sub-switch-on unit
341 First functional switch-on unit
342 Second functional switch-on unit
343 Third functional switch-on unit
344 Fourth functional switch-on unit
400 Switch cabinet system
410 Basic module
411 Housing
412 Opening
413 Basic connecting element
414 Contact
415 Basic sub-switch-on unit
416 Data line
417 (serial) data bus
418 Fieldbus connection
420 Functional module
421 Module housing
422 Opening
423 Module connecting element
424 Contact

What is claimed is:

1. A method for data transmission in a fieldbus system, having:
a transmission path via which at least one main subscriber, and
a plurality of sub-subscribers are connected to one another;
wherein the sub-subscribers each comprise a sub-switch-on unit and a functional switch-on unit connected to the sub-switch-on unit,
wherein status information indicating whether the functional switch-on unit is active or inactive is detected in each sub-subscriber,
wherein the main subscriber outputs telegrams on the transmission path,
wherein the sub-switch-on units of the sub-subscribers process the telegrams in passage wherein a telegram output by the main subscriber comprises at least one datagram which includes a control data field, a user data field and a counter field,
wherein the control data field comprises an address field and a command field,
the address field designating the sub-subscribers which are to exchange data with the user data field, and
wherein the command field defines the data transmission operations to be carried out by the sub-subscribers with the user data field;
wherein, if the command field of the datagram specifies a write operation as the data transmission operation to be carried out by the sub-subscribers, data to be written into the user data field of the datagram is made available to the sub-switch-on unit of the sub-subscriber by the functional switch-on unit when the functional switch-on unit is active,
wherein the counter field is changed by the sub-switch-on unit of the sub-subscriber, which has processed the user data field, in a predefined manner for the respective data transmission operation being carried out,
wherein the status information of the sub-subscriber addressed in the datagram is recorded with the telegram, and
wherein the datagram is assigned an expected value for the counter field which results when the user data field has been processed by the addressed sub-subscribers in accordance with the data transmission operations predefined in the command field;
wherein the main subscriber determines the expected value for the counter field of the datagram on the basis of the status information recorded with the telegram and compares it with the value of the counter field in the datagram processed by the addressed sub-subscribers in order to determine a processing error in the datagram processed by the addressed sub-subscribers in the event of a deviation.

2. The method according to claim 1, wherein:
the telegram output by the main subscriber comprises a status datagram and a data datagram,
wherein the address field of the status datagram and the address field of the data datagram designate the same sub-subscriber,
wherein for each addressed sub-subscriber, a data area for status information is provided in the user data field of the status datagram and a data area for the data to be exchanged is provided in the user data field of the data datagram, and
wherein the command field of the status datagram specifies a write operation;
wherein the main subscriber determines the expected value for the counter field of the data datagram on the basis of the detected status information in the status datagram processed by the addressed sub-subscribers and compares it with the value of the counter field in the data datagram processed by the addressed sub-subscribers in order to detect a processing error in the data datagram processed by the addressed sub-subscribers in the event of a deviation.

3. The method according to claim 2, wherein the main subscriber further checks whether in the status datagram the value in the counter field corresponds to the expected value that results when all addressed sub-subscribers have successfully carried out the write operation for entering the status information into the user data field of the status datagram.

4. The method according to claim 1, wherein:
the datagram is a status/data datagram comprising, for each addressed sub-subscriber in the user data field, a section in the data area assigned to the addressed sub-subscriber for the status information, which the main subscriber initializes with the status information indicating that the functional connection is not active, and
wherein the data transfer operations to be carried out by the sub-subscribers in the command field of the status/data datagram comprise a write operation;
wherein the main subscriber determines the expected value for the counter field of the status/data datagram on the basis of the detected status information in the status/data datagram processed by the addressed sub-subscribers and compares it with the value of the counter field in the status/data datagram processed by the addressed sub-subscribers in order to detect a processing error in the status/data datagram processed by the addressed sub-subscribers in the event of a deviation.

5. The method according to claim 1, wherein the status information indicating whether a functional connection is active or not active is 1-bit data.

6. The method according to claim 1, wherein the telegrams are Ethernet telegrams and wherein the EtherCAT protocol is used as the Ethernet protocol type for interpreting the datagrams.

7. A fieldbus system having:
a transmission path via which at least one main subscriber, and
a plurality of sub-subscribers are connected to one another;
wherein the sub-subscribers each comprise a sub-switch-on unit and a functional switch-on unit connected to the sub-switch-on unit,
wherein status information indicating whether the functional switch-on unit is active or inactive is detected in each sub-subscriber, wherein the main subscriber outputs telegrams on the transmission path,
wherein the sub-switch-on units of the sub-subscribers process the telegrams in passage,
wherein a telegram output by the main subscriber comprises at least one datagram which includes a control data field, a user data field and a counter field,
wherein the control data field comprises an address field and a command field, the address field designating the sub-subscribers which are to exchange data with the user data field, and
wherein the command field defines the data transmission operations to be carried out by the sub-subscribers with the user data field;
wherein, if the command field of the datagram specifies a write operation as the data transmission operation to be carried out by the sub-subscribers, data to be written into the user data field of the datagram is made available to the sub-switch-on unit of the sub-subscriber by the functional switch-on unit when the functional switch-on unit is active,
wherein the counter field is changed by the sub-switch-on unit of the sub-subscriber, which has processed the user data field, in a predefined manner for the respective data transmission operation being carried out,
wherein the status information of the sub-subscriber addressed in the datagram is recorded with the telegram, and
wherein the datagram is assigned an expected value for the counter field, which results when the user data field has been processed by the addressed sub-subscribers in accordance with the data transmission processes predefined in the command field;
wherein the main subscriber determines the expected value for the counter field of the datagram on the basis of the status information recorded with the telegram and compares it with the value of the counter field in the datagram processed by the addressed sub-subscribers in order to determine a processing error in the datagram processed by the addressed sub-subscribers in the event of a deviation.

8. The fieldbus system according to claim 7, wherein:
the telegram output by the main subscriber comprises a status datagram and a data datagram,
wherein the address field of the status datagram and the address field of the data datagram designate the same sub-subscriber,
wherein for each addressed sub-subscriber, a data area for status information is provided in the user data field of the status datagram and a data area for the data to be exchanged is provided in the user data field of the data datagram, and
wherein the command field of the status datagram specifies a write operation;
wherein the main subscriber determines the expected value for the counter field of the data datagram on the basis of the detected status information in the status datagram processed by the addressed sub-subscribers and compares it with the value of the counter field in the data datagram processed by the addressed sub-subscribers in order to detect a processing error in the data datagram processed by the addressed sub-subscribers in the event of a deviation.

9. The fieldbus system according to claim 8, wherein the main subscriber further checks whether in the status datagram the value in the counter field corresponds to the expected value that results when all addressed sub-subscribers have successfully carried out the write operation for entering the status information into the user data field of the status datagram.

10. The fieldbus system according to claim 7, wherein:
the datagram is a status/data datagram comprising, for each addressed sub-subscriber in the user data field, a section in the data area assigned to the addressed sub-subscriber for the status information, which the main subscriber initializes with the status information indicating that the functional connection is not active, and
wherein the data transfer operations in the command field of the status/data datagram to be carried by the sub-subscribers comprise a write operation;
wherein the main subscriber determines the expected value for the counter field of the status/data datagram on the basis of the detected status information in the status/data datagram processed by the addressed sub-subscribers and compares it with the value of the counter field in the status/data datagram processed by the addressed sub-subscribers in order to detect a processing error in the status/data datagram processed by the addressed sub-subscribers in the event of a deviation.

11. The fieldbus system according to claim 7, wherein the telegrams are Ethernet telegrams and wherein the EtherCAT protocol is used as the Ethernet protocol type for interpreting the datagrams.

12. The fieldbus system according to claim 7, wherein the sub-switch-on unit and the functional switch-on unit are realized in units in the sub-subscriber that may be separated from one another.

13. The fieldbus system according to claim 12, having a base module and a functional module, wherein:
the base module comprises the sub-switch-on unit, which is connected to a base connection element,
wherein the functional module comprises the functional switch-on unit, which is connected to a module connection element, and
wherein the base connection element and the module connection element form a plug-in connection.

14. The fieldbus system according to claim 13, wherein:
the base module comprises a plurality of sub-switch-on units which are connected to one another and to a fieldbus connection via a serial data bus, and
wherein each sub-switch-on unit is connected to a base connection element into which the module connection element of a functional module may be plugged.
